(19) United States
(12) Patent Application Publication
(10) Pub. No.: US 2003/0110152 A1
(43) Pub. Date: Jun. 12, 2003

(54) Information display apparatus

(75) Inventor: Kouichiro Hara, Tokyo (JP)

Correspondence Address: ARMSTRONG,WESTERMAN & HATTORI, LLP, 1725 K STREET, NW, SUITE 1000, WASHINGTON, DC, 20006, US

(73) Assignee: Kabushiki Kaisha Fulltime System, Tokyo (JP)

(21) Appl. No.: 10/012,324

(22) Filed: Dec. 12, 2001

(51) Int. Cl. G06F 7/00

(52) U.S. Cl. 707/1

(57) ABSTRACT

To present an information display apparatus capable of retrieving and displaying necessary data without input of data as a means of retrieval, and updating, adding or deleting data in the database server. The apparatus comprises a terminal adapter 2 for extracting a specified item of information from the data supplied through a telephone line 1, a database server 3 storing a variety of data, a database retrieval unit 4 for retrieving related data in the database server 3 on the basis of the specified data extracted by the terminal adapter 2, a display unit 5 for displaying the data retrieved by the database retrieval unit 4, and a data input and output unit 6 for updating, adding or deleting data in the database server 3, or sending input data to the telephone line 1.

### BACKGROUND OF THE INVENTION

1. Field of the Invention

The present invention relates to an information display apparatus for retrieving a specified item of information extracted from the data supplied through a telephone line, and displaying in a display unit.

2. Description of the Prior Art

The information display apparatus is widely used recently for establishing a database composed of various data in a database server, retrieving necessary data as required from said database server, and displaying the retrieved data in a display unit.

An example of application of the information display apparatus includes retrieving the data about a customer accessing by telephone, by asking the customer's telephone number and inputting the telephone number (data) through the input means. Then, the database retrieval unit retrieves the related data in the database server on the basis of the telephone number, such as the name, age, sex, and hobby, and the display unit displays the telephone number of the customer and various data retrieved by the database retrieval unit on the basis of the telephone number.

Therefore, it is possible to respond to the customer looking at the data indicated on the display such that a quick response is given without repeating the same questions or making mistakes.

In the conventional information display apparatus, however, the operator must input the customer's telephone number every time from the input means.

If a wrong telephone number is inputted by mistake at this time, data not related to the intended customer appears on the display unit.

The invention is intended to eliminate such inconvenience, and it is hence an object thereof to present an information display apparatus capable of retrieving and displaying necessary data without inputting data as a means of retrieval, updating, adding or deleting data in the database server.

### SUMMARY OF THE INVENTION

The information display apparatus according to an aspect of the invention comprises a terminal adapter for extracting a specified item of information from the data supplied through a telephone line, a database server storing a variety of data, a database retrieval unit for retrieving related data in the database server on the basis of the specified item of information extracted by the terminal adapter, and a display unit for displaying the data retrieved by the database retrieval unit.

Preferably, it may also comprise data input means for updating, adding or deleting the data in the database server, and further data output means for sending the input data to the telephone line.

### BRIEF DESCRIPTION OF THE DRAWINGS

FIG. 1 is a block diagram showing a schematic configuration of an information display apparatus in an embodiment of the invention; and

FIG. 2 is a block diagram showing a schematic configuration of a parcel delivery/pickup system having an embodiment of the invention combined with a parcel delivery/pickup apparatus.

### DESCRIPTION OF THE PREFERRED EMBODIMENTS

An embodiment of the invention is explained below by referring to the drawing.

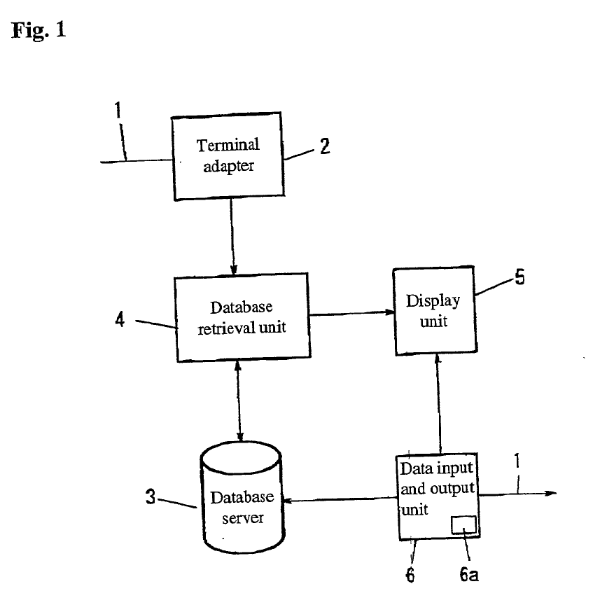

FIG. 1 is a block diagram showing a schematic configuration of an information display apparatus in an embodiment of the invention.

In FIG. 1, the reference numeral 1 denotes a telephone line, and the reference number 2 denotes a terminal adapter. Said terminal adapter 2 is to extract and issue specified item of information, for example, telephone number, from the data supplied through the telephone line.

The reference numeral 3 denotes a database server storing a database composed of various data, and 4 is a database retrieval unit, and said database retrieval unit 4 is to retrieve and issue related data in the database server 3 on the basis of the telephone number extracted by the terminal adapter 2.

The reference numeral 5 denotes a display unit, which displays the data retrieved on the basis of the telephone number by the database retrieval unit 4.

The reference numeral 6 denotes a data input/output unit, which is composed of data input/output means for updating or adding the data in the database server 3 or imputting data to be deleted, and data output means for sending input data to the telephone line 1.

The data input/output unit 6 includes an operation section 6a.

Next, the operation is explained.

First, the terminal adapter 2 extracts the telephone number of the sender (customer) from the number display data supplied through the telephone line 1, The telephone number extracted by the terminal adapter 2 is put into the database retrieval unit 4 such that the database retrieval unit 4 retrieves data relating to the extracted telephone number from the database server 3, and sends to the display unit 5.

Therefore, the display unit 5 displays various data on the basis of the telephone number of the customer extracted by the terminal adapter 2, such as the telephone number, name, age, sex, and hobby.

When updating, adding or deleting data in the database server 3, the operation section 6a of the data input/output unit 6 is operated such that the customer data can be updated, added or deleted.

Alternatively, necessary data displayed in the display unit 5 are checked and if necessary the operation section 6a of the data input/output unit 6 is operated such that necessary data can be sent out to the telephone line 1.

Thus, the data inputted into the operation section 6a is also issued and displayed in the display unit 5 so that the data can be processed while being monitored.

According to this embodiment of the invention, the telephone number is extracted by the terminal adapter 2 from the data supplied through the telephone line 1, and data relating to the extracted telephone number is retrieved from the database server 3, and therefore it is not necessary to input the data as a mans of retrieval.

Therefore, the possibility of input error of data as a means of retrieval is eliminated such that accurate data can be displayed in the display unit 5.

Moreover, since the data input/output unit 6 is provided, the existing data can be updated, newly needed data can be added, or undesired data can be deleted, and also necessary data can be transmitted.

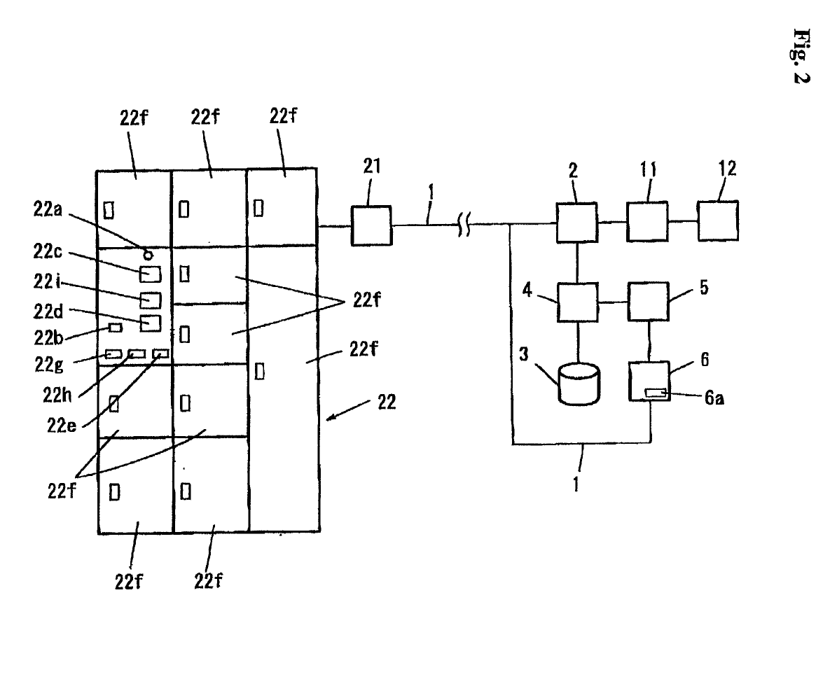

FIG. 2 is a block diagram showing a schematic configuration of a parcel delivery/pickup system having an embodiment of the invention combined with a parcel delivery/pickup apparatus, and since similar parts to those in FIG. 1 are identified with similar reference numerals, and an explanation thereof is omitted.

In FIG. 2, the reference numeral 11 denotes a private branch exchange, and the reference numeral 12 denotes a telephone set connected to the private branch exchange 11.

The reference numeral 21 denotes a modulator-demodulator (modem) connected to the telephone line 1, and the numeral 22 denotes a parcel delivery/pickup apparatus connected to the modem 21.

The configuration of the parcel delivery/pickup apparatus 22 is explained together with its operation and performance.

Next, the parcel delivery/pickup operation will be explained.

The parcel delivery/pickup apparatus 22 is installed in a condominium or a similar complex.

The information display apparatus is installed in a management center, and the parcel delivery/pickup apparatus 22 is videotaped by a security camera 22a so as to be monitored in the management center.

If the recipient is absent, the deliveryman stands in front of the parcel delivery/pickup apparatus 22, and a sensor 22b senses the his or her figure such that a menu is shown in a monitor 22c.

Then, when “Deposit of Parcel” is selected on the monitor 22c by pressing the numeral “1” on the ten-keys of an operation section 22d, the selected screen of “Deposit of Parcel” is displayed in magnified characters in the monitor 22c, and a voice message instructing “If the input is found correct, please press the CONFIRM KEY” is given from a speaker 22e.

By pressing the CONFIRM KEY in the operation section 22d, the speaker 22 gives a voice message “Input the room number of the recipient,” and when the room number is inputted by pressing the ten-keys of the operation section 2d, the resident's name having said room number inputted by the ten-keys is displayed on the monitor 22c, and the speaker 22e instructs again “Check the name of the recipient and press CONFIRM KEY.”

When the CONFIRM KEY in the operation section 22d is pressed, the monitor 22c displays a list of delivery service companies and the speaker 22e requests “Select your company list from the list, and input the corresponding number”. When the company number is inputted by operating the ten-keys of the operation section 22d, the selected company name is displayed in magnified characters in the monitor 22c, when the speaker 22e urges “Please confirm.”

When the CONFIRM KEY in the operation section 22d is pressed, the monitor 22c displays empty lockers 22f among plural lockers 22f, and the speaker 22e urges “Select an empty locker, and input its number,” and when the number is inputted by operating the ten-keys of the operation section 22d, the selected locker number is displayed in magnified characters in the monitor 22c, and the speaker 22e urges “Please confirm.”

Next, if the CONFIRM KEY in the operation section 22d is pressed, the electronic key of the selected locker is unlocked, and the monitor 22c shows “Locker is open” while the speaker 22e instructs “Place the parcel on the circle mark in the center of the locker, and close the locker door by hand.”

When the parcel is placed in the selected locker 22f and the door of the locker 22f is closed, the parcel is detected by the sensor such that the electronic key of the selected locker 22f is locked, when the monitor 22c indicates “a Parcel Deposit Slip and a Delivery Note will be issued. Please put the Delivery Note into the mailbox of the recipient. Thank you.” At the same time, the speaker announces “Parcel Deposit Slip and a Delivery Note will be issued. Please put the Delivery Note into the mailbox of the recipient. Thank you.” Then, the Parcel Deposit Slip and the Delivery Note are issued from a receipt issue unit 22g.

This completes the parcel delivery operation to deposit the parcel into the parcel delivery/pickup apparatus 22.

In this connection, wrong input operation can be corrected by correction keys in the operation section 22d. If the operation is to be started again from the beginning to correct a mistake, the start key of the operation section 22d may be pressed, and then, the whole process can be started again from the beginning.

When the deposit of parcel is over and the sensor 22b no longer senses the figure of the deliveryman, the monitor 22c stops the display a while later, and is set in a standby state.

Next, when the recipient is to pick up the parcel, he or she stands in front of the parcel delivery/pickup apparatus 22 such that the sensor 22b senses his or her figure to display the menu screen on the monitor 22c. When the “Pickup” is selected by pressing the ten-key 2 of the operation section 22d while viewing the monitor 22c, the speaker 22e instructs “Please insert your card into the card reader.”

When the user card having identification data recorded therein is inserted into the card reader 22h, the data is read out from the card to be compared with the room number data inputted during the delivery operation and when matched, the electronic key of the locker 22f corresponding to the room number is unlocked, and the monitor 22c indicates “Locker Open”, and the speaker 22c urges “Locker is open. Pick up the parcel and close the door.”

When the parcel is taken out from the locker 22f and the door of the locker 22f is closed, the electronic key of the locker 22f is locked and the monitor 22c displays “Thank you very much” and the speaker 22d announces “Thank you very much.”

This completes the pickup of the parcel from the parcel delivery/pickup apparatus 22.

In this connection, a wrong input operation can be corrected by pressing the correction key in the operation section 22d. If the operation is to be started again from the beginning to correct the mistake, the start key of the operation section 22d may be pressed, and then, the whole process can be started again from the beginning.

When the pickup operation of the parcel is over and the sensor 22b no longer senses the figure of the recipient, the monitor 22c stops the display a while later, and is set in a standby state.

In case of any trouble, it is possible to get in touch with the management center as explained below.

First, the recipient calls the management center by using a hands-free telephone set 22i installed in the parcel delivery/pickup apparatus 22, the above-mentioned management center display unit 5 shows from which parcel delivery/pickup apparatus 22 the call is made according to the telephone number by the information display apparatus, and the administration center can immediately attend to the trouble by the telephone set 12.

At this time, if the recipient has lost his or her own user card, the specified locker 22f can be unlocked by sending specified data to operate the operation section 6a of the data input and output unit 6 if the person can be identified to be the resident of the room by any other means and the parcel can be picked up by the recipient

If, for example, the parcel is not picked up from the specified locker 22f for two days, a telephone call is made from the management center to the recipient to urge to pick up the parcel.

As an application example of the invention, the parcel delivery system has been shown, but it may be also applied in a telephone order system combined with a telephone order receiving apparatus of mail-order sales service.

If applied in the telephone order receiving system, inputting of data as a means of retrieval may be omitted such that a quick response is realized, and the waiting time for the customer.

Instead of the telephone number, other data such as a membership number by using dial can be also used.

Thus, according to the invention, specified data such as telephone number can be extracted by the terminal adapter from the data supplied through the telephone line, and data relating to the extracted telephone number is retrieved from the database server, and therefore it is not necessary to input the data as a means of retrieval.

Hence, the possibility of input error of data as a means of retrieval is eliminated, and accurate data can be shown in the display unit.

Moreover, since the data input means is provided, the existing data can be updated, newly needed data can be added, or undesired data can be deleted.

Further, since the data output means for issuing input data to the telephone line is provided, necessary data can be transmitted.

What is claimed is:

1. An information display apparatus comprising:
a terminal adapter for extracting a specified item of information from the data supplied through a telephone line;
a database server storing a variety of data;
a database retrieval unit for retrieving related data in the database server on the basis of the specified item of information extracted by said terminal adapter; and
a display unit for displaying data related to the specified item of information retrieved by said database retrieval unit.

2. The information display apparatus of claim 1, further comprising:
data input means for updating, adding or deleting the data in the database server.

3. The information display apparatus of claim 1 or 2, further comprising:
data output means for sending the input data to the telephone line.

4. The information display apparatus of claim 1, wherein said data supplied through a telephone line includes data contained in a call from a parcel delivery/pickup apparatus.
